(19) United States
(12) Patent Application Publication
(10) Pub. No.: US 2022/0037649 A1
(43) Pub. Date: Feb. 3, 2022

(54) ALL SOLID-STATE LITHIUM-ION CATHODE

(71) Applicants: Samsung Electronics Co., Ltd., Suwon-si (KR); The Regents of the University of California, Oakland, CA (US)

(72) Inventors: Srinath Chakravarthy, Glastonbury, CT (US); Jeong-Ju Cho, Mountain View, CA (US); Qingsong Tu, Berkeley, CA (US); Tan Shi, Berkeley, CA (US); Gerbrand Ceder, Berkeley, CA (US)

(21) Appl. No.: 17/116,583

(22) Filed: Dec. 9, 2020

Related U.S. Application Data
(60) Provisional application No. 63/058,005, filed on Jul. 29, 2020.

(51) Int. Cl. H01M 4/36; H01M 4/131; H01M 4/134; H01M 4/1391; H01M 4/1395; H01M 4/1393; H01M 4/133; H01M 4/525; H01M 4/505; H01M 4/66; H01M 4/04; H01M 10/0525

(52) U.S. Cl. CPC H01M 4/366; H01M 4/131; H01M 4/134; H01M 4/1391; H01M 4/1395; H01M 4/1393; H01M 2004/028; H01M 4/525; H01M 4/505; H01M 4/661; H01M 4/364; H01M 4/0471; H01M 10/0525; H01M 4/133

(57) ABSTRACT

A positive active material layer includes a positive active material comprising a plurality of particles having multi-modal particle size distribution, wherein the multi-modal particle size distribution comprises a first particle size distribution having a first mean particle diameter (D₁) and a second particle size distribution having a second mean particle diameter (D₂); a conductive agent; and a solid electrolyte comprising particles having a mean particle diameter (D_{SE}) of 0.1 micrometers to 12 micrometers, wherein each of the first mean particle diameter and the second mean particle diameter are independently 1 micrometer to 50 micrometers.

### CROSS-REFERENCE TO RELATED APPLICATION

This application claims priority to U.S. Provisional Patent Application No. 63/058,005, filed on Jul. 29, 2020, in the United States Patent and Trademark Office, and all the benefits accruing therefrom under 35 U.S.C. § 119, the content of which is incorporated herein in its entirety by reference.

### BACKGROUND

### 1. Field

Disclosed is an all solid-state positive electrode, a lithium battery including the positive electrode, and a method of preparing the positive electrode.

### 2. Description of the Related Art

Solid-state lithium batteries are of interest because they can potentially offer improved specific energy and energy density, and improved safety, and in some configurations improved power density. However, the performance of currently available solid-state lithium batteries illustrates the performance gap between currently available lithium-ion batteries using liquid electrolytes and solid-state alternatives.

Currently a positive electrode may have approximately 80% loading for maximum utilization. In some cases, to achieve a high packing density of a composite electrode greater than 80%, a ratio (λ) of the mean particle diameter of the positive active material particles to the mean particle diameter of the solid electrolyte particles, where λ>8, may also be required. Currently, very small solid electrolyte particles are used to achieve λ>8, which increases impedance in a cathode. A positive electrode that includes a solid electrolyte with a mean particle diameter of less than 1.5 μm has increased impedance, lower rate capacity, and lower energy density. Thus, a positive electrode material having improved performance, the safety properties associated with a solid-state material, without the safety issues associated with use of the liquid electrolytes is desired. Therefore, there remains a need for an improved solid-state positive electrode.

### SUMMARY

Disclosed is a positive electrode having improved loading, high energy density, and improved ionic conductivity, a lithium battery including the positive electrode, and a method of preparing the positive electrode.

In an aspect, a positive active material layer includes a positive active material including a plurality of particles having multi-modal particle size distribution, wherein the multi-modal particle size distribution includes a first particle size distribution having a first mean particle diameter (D₁) and a second particle size distribution having a second mean particle diameter (D₂); a conductive agent; and a solid electrolyte including particles having a mean particle diameter (D_{SE}) of 0.1 micrometers to 12 micrometers, wherein each of the first mean particle diameter and the second mean particle diameter are independently 1 micrometer to 50 micrometers.

In an aspect, a positive electrode includes a current collector; and the positive active material layer on a surface of the current collector.

In an aspect, a lithium battery includes the positive active material layer; a negative electrode comprising a metal current collector; and a solid electrolyte disposed between the positive electrode and the negative electrode.

In an aspect, a method of preparing a positive active material layer includes providing a mixture including a first particle having a first mean particle diameter (D₁) of between 1 micrometer and 50 micrometers, a second particle having a second mean particle diameter (D₂) between 1 micrometer to 50 micrometers; combining the mixture with a conductive agent and a solid electrolyte having a mean particle diameter (D_{SE}) of 0.1 micrometers to 12 micrometers to form a positive active material precursor; and compacting the positive active material precursor at 50 megapascals to 500 megapascals to form the positive active material layer, wherein a positive active material in the positive active material layer comprises a plurality of particles having multi-modal particle size distribution, wherein the mufti-modal particle size distribution includes a first particle size distribution having a first mean particle diameter and a second particle size distribution having a second mean particle diameter.

### BRIEF DESCRIPTION OF THE DRAWINGS

The above and other advantages and features of this disclosure will become more apparent by describing in further detail exemplary embodiments thereof with reference to the accompanying drawing, in which:

FIG. 1 is a schematic illustration of a battery.

### DETAILED DESCRIPTION

Solid-state lithium batteries are intriguing because they potentially can provide specific energy and energy density competitive with liquid-electrolyte alternatives, without the safety issues associated with liquid electrolytes. However, materials developed for lithium or lithium-ion batteries using liquid electrolytes, in particular those using a lithium nickel oxide positive active material, e.g., an NCM of the formula Li₁₊ₓ(Ni_{1-y-z}Co_{y}Mn_{z})O₂, do not offer comparable performance when used in solid-state lithium or lithium-ion batteries. While not wanting to be bound by theory, it is understood that effects unique to solid-state electrolytes, such as degradation of the solid electrolyte when contacted with a conductive diluent such as carbon black (often used in positive electrodes for liquid electrolytes), result in unexpected and significant differences when such materials are used in solid-state batteries as opposed to with liquid electrolytes.

To provide an energy density comparable to when a liquid electrolyte is used, at least 90% utilization of a positive electrode active material in an electrode comprising at least 80 weight percent (wt %) of the positive electrode active material is desired. The utilization (θ_{CAM}) of a positive electrode composite is the ratio of the volume of the active cathode active material particles to the total cathode active material volume. To provide 90% utilization, the particle size of the positive electrode active material is reduced, e.g., to a D₅₀ (mean particle diameter) of 4 μm or less, and a small solid-state electrode particle size, e.g., a mean particle diameter of less than 1.5 μm is used. However, use of a solid electrolyte having a small particle size results in increased impedance and lower rate capability. Thus providing both high energy density and high rate capability in solid state positive electrode materials has been elusive.

As used herein, “average particle size,” “mean particle diameter,” or “D₅₀ particle size” refers to a particle diameter corresponding to 50% of the particles in a distribution curve in which particles are accumulated in the order of particle diameter from the smallest particle to the largest particle and a total number of accumulated particles is 100%. The mean particle diameter may be measured by methods known to those of skill in the art. For example, the mean particle diameter may be as determined with a commercially available particle size analyzer by, e.g., dynamic light scattering, or may be measured using a transmission electron microscope (TEM) or a scanning electron microscope (SEM). When determined by TEM or SEM, an average longest dimension of a particle may be used.

The Applicants have discovered previously undisclosed interactions between the positive active material and solid electrolyte materials. While not wanting to be bound by theory, it is understood that when the positive active material is considered alone, charge transport restrictions in the positive active material, such as NCM, motivate use of small particle sizes, e.g., 4 μm or less. However, it has been surprisingly discovered that the interactions between the positive electrode material and the solid electrolyte are often more significant than charge transport restrictions in the positive active material. In detail, ionic transport limitations at particle surfaces and between positive active material particles and solid electrolyte particles have been discovered to be of such significance that improved performance can be provided by using a selected combination of positive active materials to provide a multi-modal positive active material particle size, and a solid electrolyte having a selected particle size, particularly when using a nickel-containing positive active material, such as nickel-cobalt-manganese oxides (NCM).

The inventors have surprisingly found that a positive active material layer comprising a positive active material comprising a plurality of particles having a multi-modal particle size distribution, wherein the multi-modal particle size distribution comprises a first particle size distribution having a first mean particle diameter (D₁) and a second particle size distribution having a second mean particle diameter (D₂); a conductive agent; and a solid electrolyte comprising particles having a mean particle diameter (D_{SE}) of 0.1 micrometers (μm) to 12 μm, wherein each of the first mean particle diameter and the second mean particle diameter are independently 1 μm to 50 μm, has unexpectedly decreased impedance, higher rate capacity, and increased energy density compared to commercially available composite positive electrode materials.

In the positive active material layer, the weight fraction of the positive active material may be greater than 90% while maintaining a utilization of at least 80% by using a multi-modal distribution of positive active material particles and solid electrolyte particles with a mean particle diameter of 1 μm to 50 μm. Despite the fact that relatively large solid electrolyte particles are used, the disclosed composite cathode material layer has unexpectedly improved conductivity, which is understood to result in improved rate capability. Also, the relatively large solid electrolyte particle size results in improved manufacturability.

In an aspect, a positive electrode active material layer comprises a positive active material comprising a plurality of positive active material particles having multi-modal particle size distribution, wherein the multi-modal particle size distribution comprises a first particle size distribution having a first mean particle diameter (D₁) and a second particle size distribution having a second mean particle diameter (D₂); a conductive agent; and a solid electrolyte comprising particles having a mean particle diameter (D_{SE}) of 0.1 μm to 12 μm, wherein each of the first mean particle diameter and the second mean particle diameter are independently 1 μm to 50 μm.

In an aspect, the positive active material layer may have a ratio (ψ) of D₂ to D₁ that is equal to or greater than 0.05. For example, a ratio (ψ) of D₂ to D₁ may be 0.05≤ψ≤0.5, 0.1≤ψ≤0.5, 0.15≤ψ≤0.45, or 0.2≤ψ≤0.4.

The positive active material layer may have a ratio of a weight of particles corresponding to the second particle size distribution to a total weight of the positive active material of 0.1 to 0.5. For example, a ratio of a weight of particles corresponding to the second particle size distribution to a total weight of the positive active material in the positive active material layer may be 0.1 to 0.5, 0.15 to 0.45, 0.2 to 0.4, or 0.25 to 0.35.

In an aspect, D₁ is 3 μm to 25 μm and D₂ is 1 μm to 15 μm. For example, D₁ may be 3 μm to 25 μm, 5 μm to 20 μm, or 7 μm to 15 μm. Also, D₂ may be 1 μm to 15 μm, 3 μm to 12 μm, or 5 μm to 10 μm. Any suitable combination of D₁ and D₂ may be used.

The weight fraction of the positive active material in the positive active material layer may be 70 weight percent (wt %) of a total weight of the positive active material. For example, the total weight of the positive active material of particles corresponding to the first particle size distribution and the second particle size distribution may be 70 wt % to 100 wt %, 75 wt % to 95 wt %, or 80 wt % to 90 wt % of a total weight of the positive active material layer.

The positive active material layer comprises particles corresponding to the first particle size distribution and particles corresponding to the second particle distribution, which may each independently comprise a lithium transition metal oxide, a lithium transition metal phosphate, or a combination thereof.

The positive active material layer may comprise particles corresponding to the first particle size distribution and the particles corresponding to the second particle distribution that are each independently a lithium transition metal oxide comprising nickel, cobalt, aluminum, manganese, lithium iron phosphate, or a combination thereof.

The positive active material active material layer comprises particles corresponding to the first particle size distribution and the particles corresponding to the second particle distribution that are each independently a lithium transition metal oxide, a lithium iron phosphate, or a combination thereof. The positive active material can include a compound represented by any of the Formulas: LiₚM¹_{1-q}M²_{q}D₂ wherein 0.90≤p≤1.8 and 0≤q≤0.5; LiₚE_{1-q}M²_{q}O₂₋ₓDₓ wherein 0.90≤p≤1.8, 0≤q≤0.5, and 0≤x≤0.05; LiE_{2-q}M²_{q}O₄₋ₓDₓ wherein 0≤q≤0.5 and 0≤x≤0.05; LiₚNi_{1-q-r}CO_{q}M²ᵣDₓ wherein 0.90≤p≤1.8, 0≤q≤0.5, 0≤r≤0.05, and 0<x≤2; LiₚNi_{1-q-r}CoₚM²ᵣO₂₋ₓXₓ wherein 0.90≤p≤1.8.0≤q≤0.5, 0≤r≤0.05, and 0<x≤2; LiₚNi_{1-q-r}CoₚM²ᵣO₂₋ₓXₓ wherein 0.90≤p≤1.8, 0≤q≤0.5, 0≤r≤0.05, and 0<x<2; LiₚN_{1-q-r}Mn_{q}M²ᵣDₓ wherein 0.90≤p≤1.8, 0≤q≤0.5, 0≤r≤0.05, and 0<x≤2; LiₚNi_{1-q-r}Mn_{q}M²ᵣO₂₋ₚXₓ wherein 0.90≤p≤1.8, 0≤q≤0.5, 0≤r≤0.05, and 0<x<2; LiₚNi_{1-q-r} Mn_{q}M²ᵣO₂₋ₓXₓ wherein 0.90≤p≤1.8, 0≤q≤0.5, 0≤r≤0.05, and 0<x<2; LiₚNi_{1-q-r}G_{d}O₂ wherein 0.90≤p≤1.8, 0≤q≤0.9, 0≤r≤0.5, and 0.001≤d≤0.1; LiₚNi_{q}CoᵣMn_{d}GeO₂ wherein 0.90≤p≤1.8, 0≤q≤0.9, 0≤r≤0.5, 0≤d≤0.5, and 0.001≤e≤0.1; LiₚNiG_{q}O₂ wherein 0.90≤p≤1.8 and 0.001≤q≤0.1; LiₚCoG_{q}O₂ wherein 0.90≤p≤1.8 and 0.001≤q≤0.1; LiₚMnG_{q}O₂ where 0.90≤p≤1.8 and 0.001≤q≤0.1; LiₚMn₂G_{q}O₄ wherein 0.90≤p≤1.8 and 0.001≤q≤0.1; QO₂; QS₂; LiQS₂; V₂O₅; LiV₂O₂; LiRO₂; LiNiVO₄; Li_{(3-f)}J₂(PO₄)₃ (0≤f≤2); Li_{(3-f)}Fe₂(PO₄)₃ wherein 0≤f≤2; and LiFePO₄, in which in the foregoing positive active materials M¹ is Ni, Co, or Mn; M² is Al, Ni, Co, Mn, Cr, Fe, Mg, Sr, V, or a rare-earth element; D is O, F, S, or P; E is Co or Mn; X is F, S, or P; G is Al, Cr, Mn, Fe, Mg, La, Ce, Sr, or V; Q is Ti, Mo or Mn; R is Cr, V, Fe, Sc, or Y; and J is V, Cr, Mn, Co, Ni, or Cu. Examples of the positive active material include LiCoO₂, LiMnₓO₂ₓ where x=1 or 2, LiNi₁₋ₓMnₓO₂ₓ where 0<x<1, LiNi_{1-x-y}CoₓMn_{y}O₂ where 0≤x≤0.5 and 0≤y≤0.5, LiFePO₄, TiS₂, FeS₂, TiS₃, and FeS₃.

In an aspect, the positive active material may include lithium cobalt oxide, lithium nickel cobalt manganese oxide, lithium nickel cobalt aluminum oxide, or a combination thereof. Mentioned is an aspect in which the positive active material is a NCA or a NCM material represented by LiₓNi_{y}E_{z}G_{d}O₂ wherein 0.90≤x≤1.8, 0≤y≤0.9, 0≤z≤0.5, 0.001≤d≤0.1, E is Co, and G is Al, Cr, Mn, Fe, Mg, La, Ce, Sr, V, or a combination thereof. An aspect in which y is 5, E is Co, G is Mn, z is 3, and d is 2, i.e., LiNi_{0.5}Co_{0.3}Mn_{0.2}O₂, (NCM532) is mentioned. Also is an aspect in which y is 8, E is Co, G is Mn, z is 1, and d is 1, i.e., LiNi_{0.8}Co_{0.1}Mn_{0.1}O₂, (NCM811). Mentioned is use of an NCM811 having a first mean particle diameter, and a NCM811 having a second mean particle diameter, wherein the first mean particle diameter and the second mean particle diameter are different.

The positive active material layer may comprise a conductive agent, which may be, for example, graphite, carbon fiber, activated carbon, carbon nanotubes, carbon black, amorphous carbon, or a combination thereof. The conductive agent can include, for example, carbon black, carbon fiber, graphite, carbon nanotubes, graphene, or a combination thereof. The carbon black can be, for example, acetylene black, Ketjen black, Super P carbon, channel black, furnace black, lamp black, thermal black, or a combination thereof. The graphite can be a natural graphite or an artificial graphite. A combination comprising at least one of the foregoing conductive agents can be used. The positive electrode can additionally include an additional conductor other than the carbonaceous conductor described above. The additional conductor can be an electrically conductive fiber, such as a metal fiber; a metal powder such as a fluorinated carbon powder, an aluminum powder, or a nickel powder; a conductive whisker such as a zinc oxide or a potassium titanate; or a polyphenylene derivative. A combination comprising at least one of the foregoing additional conductors can be used.

The positive active material layer comprises a solid electrolyte. The solid electrolyte may comprise, for example, a sulfide solid electrolyte, an oxide solid electrolyte, or a combination thereof.

The solid electrolyte may comprise a sulfide solid electrolyte, and may comprise Li₂S—P₂S₅, Li₂S—P₂S₅—LiX, wherein X is a halogen element. Li₂S—P₂S₅—Li₂O, Li₂S—P₂S₅—Li₂₀—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ, wherein m and n are positive numbers. Z is one of GE, Zn or Ga, Li₂S—GeS₂, Li₂S—SiS₂—Li₃PO₄, Li₂S—SiS₂-LiₚM¹O_{q} wherein p and q are positive numbers. M¹ is P, Si, Ge, B, Al, Ga, or In, Li₇₋ₓPS₆₋ₓClₓ wherein 0<x<2. Li₇₋ₓPS₆₋ₓBrₓ wherein 0<x<2, or Li₇₋ₓPS₆₋ₓIₓ wherein 0<x<2. Mentioned are Li₆PS₅Cl, Li₆PS₅Br, or Li₆PS₅I. When the positive active material layer comprises a sulfide solid electrolyte, the sulfide solid electrolyte may be Li₂S—P₂S₅, Li₂S—P₂S₅—LiX, or a combination thereof, wherein X is at least one halogen element.

The solid electrolyte may comprise an oxide solid electrolyte, and may comprise Li_{1+x+y}AlₓTi₂₋ₓSi_{y}P_{3-y}O₁₂ wherein 0<x<2, 0≤y<3. BaTiO₃, Pb(Zr₍₁₋ₓ₎Tiₓ)O₃ wherein 0≤x≤1, Pb₁₋ₓLaₓZr_{1-y}Ti_{y}O₃ wherein 0≤x<1, 0≤y<1, Pb(Mg_{1/3}Nb_{2/3})O₃—PbTiO₃, HfO₂, SrTiO₃, SnO₂, CeCO₂, Na₂O, MgO, NiO, CaO, BaO, ZnO, ZrO₂, Y₂O₃, Al₂O₃, TiO₂, SiO₂, SiC, L₃PO₄, LiₓTi_{y}(PO₄)₃ wherein 0<x<2,0<y<3). LiₓAl_{y}Ti_{z}(PO₄)₃, 0<x<2, 0<y<1, 0<z<3), Li_{1+x+y}(Al₍₁₋ₘ₎Gaₘ)ₓ(Ti₍₁₋ₙ₎Geₙ)₂₋ₓSi_{y}P_{3-y}O₁₂ (0≤x≤1, 0≤y≤1, 0≤m≤1, and 0≤n≤1, LiₓLa_{y}TiO₃ wherein 0<x<2, 0<y<3, LiₓGe_{y}P_{z}S_{w} wherein 0<x<4, 0<y<1, 0<z<1, and 0<w<5. LiₓN_{y} wherein 0<x<4 and 0<y<2, SiS₂, LiₓSi_{y}S_{z} wherein 0<x<3, 0<y<2, 0<z<4, LiₓP_{y}S_{z} wherein 0<x<3, 0<y<3 and 0<z<7, Li₂O, LiF, LiOH, Li₂CO₃, LiAlO₂, a Li₂O—Al₂O₃—SiO₂—P₂O₅—TiO₂—GeO₂ ceramic, a garnet ceramic of the formula Li₃₊ₓLa₃M¹₂O₁₃ wherein M¹ is Te, Nb or Zr and x is an integer of 1 to 10, or a combination thereof. Mentioned are (La₁₋ₓLiₓ)TiO₃ (LLTO) wherein 0<x<1, Li₇₋₃ₓAlₓLa₃Zr₂O₁₂ (LLZO), and Li_{1.3}Al_{0.3}Ti_{1.7}(PO₄)₃ (LATP).

The oxide solid electrolyte may comprise an oxide of the formula Li₅₊ₓE₃(Me²_{z}Me²_{(2-z)})O_{d} wherein E is a trivalent cation; Me¹ and Me² are each independently one of a trivalent, tetravalent, pentavalent, and a hexavalent cation; 0<x≤3, 0≤z<2, and 0<d≤12; and O can be partially or totally substituted with a pentavalent anion, a hexavalent anion, a heptavalent anion, or a combination thereof. For example, E can be partially substituted with a monovalent or divalent cation. In another embodiment, for example, in the solid ion conductor, when 0<x≤2.5, E may be La and Me² can be Zr. In an aspect, the oxide can be of the formula Li_{5+x+2y}(D_{y}E₃₋₇)(Me¹_{z}Me²_{2-z})O_{d} wherein D is a monovalent or divalent cation; E is a trivalent cation; Me¹ and Me² are each independently a trivalent, tetravalent, pentavalent, or a hexavalent cation; 0<x+2y≤3, 0<y≤0.5, 0≤z<2, and 0<d≤12; and O can be partially or totally substituted with a pentavalent anion, a hexavalent anion, a heptavalent anion, or a combination thereof. The preferred number of moles of lithium per formula unit (Li-pfu) in the above formula is 6<(5+x+2y)<7.2, 6.2<(5+x+2y)<7, 6.4<(5+x+2y)<6.8. In the garnet-type oxides of the above formulas, D can comprise potassium (K), rubidium (Rb), cesium (Cs), calcium (Ca), barium (Ba), or strontium (Sr). In an embodiment, D is calcium (Ca), barium (Ba), or strontium (Sr). In the above formulas, Me can be a transition metal. For example, Me can be tantalum (Ta), niobium (Nb), yttrium (Y), scandium (Sc), tungsten (W), molybdenum (Mo), antimony (Sb), bismuth (Bi), hafnium (Hf), vanadium (V), germanium (Ge), silicon (Si), aluminum (Al), gallium (Ga), titanium (Ti), cobalt (Co), indium (In), zinc (Zn), or chromium (Cr). Mentioned is Li_{6.5}La₃Zr_{1.5}Ta_{0.5}O₁₂.

In an aspect, the oxide solid electrolyte may have any suitable structure, e.g., a garnet structure a perovskite structure, or an argyrodite structure. A representative example of a garnet solid electrolyte includes Li_{6.5}La₃Zr_{1.5}Ta_{0.5}O₁₂. An example of a perovskite solid electrolyte may be Li_{0.33}La_{0.5}TiO₃.

The positive active material layer may have a ratio (λ) of D₁ to D_{SE} that is equal to or greater than 1. For example, the ratio (λ) of D₁ to D_{SE} may be 1≤λ≤50, 2≤λ≤40, 3≤λ≤30, or 4≤λ≤20. A ratio (λ) of D₁ to D_{SE}, wherein 2≤λ≤30 is mentioned.

The positive active material layer may have a ratio (f_{CAM}) of a total weight of the positive active material (W_{CAM}) to the total weight of the positive active material layer (W_{TOT}) that is equal to or greater than 0.5. For example, the ratio (f_{CAM}) of a total weight of the positive active material (W_{CAM}) to the total weight of the positive active material layer (W_{TOT}) may be 0.5≤f_{CAM}≤93, 0.55≤f_{CAM}≤92.5, 0.6≤f_{CAM}≤92, or 0.65≤f_{CAM}≤91.5. A ratio (f_{CAM}) of a total weight of the positive active material (W_{CAM}) to the total weight of the positive active material layer (W_{TOT}), wherein 0.7≤f_{CAM}≤92.5 is mentioned.

In the positive active material layer, ϕ is a ratio a weight of the second particle (W₂) to a total weight of the positive active material (W_{CAM}), wherein ϕ may be, for example, 0.1≤ϕ≤0.5, 0.15≤ϕ≤0.45, 0.2≤ϕ≤0.4, or 0.25≤ϕ≤0.35.

In the positive active material layer, D_{SE} satisfies (D₁/(8.926−13.41ψ+3.762ϕ))≤D_{SE}≤D₂.

In an aspect, a positive electrode comprises a current collector; and the positive active material layer described herein is on a surface of the current collector. The positive electrode can be prepared by forming a positive active material layer including the positive active material on the current collector. The current collector may comprise aluminum, for example.

In an aspect, a lithium battery comprises the positive electrode comprising the positive active material layer on a surface of the current collector; a negative electrode comprising a metal current collector; and a solid electrolyte disposed between the positive electrode and the negative electrode. In an aspect, the negative electrode in the lithium battery may further comprise carbon, lithium, a lithium metal alloy, or a combination thereof between on the current collector and opposite the positive electrode active material.

In an aspect, a method of preparing a positive active material layer is disclosed. The method comprises providing a mixture comprising a first particle having a first mean particle diameter (D₁) of between 1 μm and 50 μm, a second particle having a second mean particle diameter (D₂) between 1 μm to 50 μm; combining the mixture with a conductive agent and a solid electrolyte having a mean particle diameter (D_{SE}) of 0.1 μm to 12 μm to form a positive active material precursor; and compacting the positive active material precursor at 50 megapascals (MPa) to 500 MPa to form the positive active material layer, wherein a positive active material in the positive active material layer comprises a plurality of particles having multi-modal particle size distribution, wherein the multi-modal particle size distribution comprises a first particle size distribution having a first mean particle diameter and a second particle size distribution having a second mean particle diameter.

In an aspect, the foregoing method may provide a positive active material layer having a ratio (ψ) of D₂ to D₁ that is equal to or greater than 0.05. For example, a ratio (ψ) of D₂ to D₁ is 0.05≤ψ≤0.5, 0.1≤ψ≤0.5, 0.15≤ψ≤0.45, or 0.2≤ψ≤0.4.

In an aspect, the foregoing method may provide a positive active material layer having D₁ of 3 μm to 25 μm and D₂ of 1 μm to 15 μm. For example, D₁ may be 3 μm to 25 μm, 5 μm to 20 μm, or 7 μm to 15 μm and D₂ may be 1 μm to 15 μm, 3 μm to 12 μm, or 5 μm to 10 μm.

In an aspect, the foregoing method may provide a positive active material layer having a packing density of particles corresponding to the first particle size distribution and particles corresponding to the second particle size distribution in the positive active material layer of equal to or greater than 80 percent (%), based on a total weight of the positive active material layer. A packing density in the positive active material layer may be 80% to 100%, or 85% to 95% based on a total weight of the positive active material.

In an aspect, the foregoing method may have an active material loading in the positive active material layer of equal to or greater than 90 percent (%), based on a total weight of the positive active material layer. For, example, the active material loading in the positive active material may be 90% to 100%, 92% to 98%, 94% to 96%.

In an aspect, the positive active material layer may comprise a solid electrolyte having a mean particle diameter (D_{SE}) of 0.1 μm to 12 μm. The D_{SE} of the solid electrolyte may be, for example, 0.1 μm to 12 μm, 0.5 μm to 10 μm, 1 μm to 8 μm, or 1.5 μm to 6 μm.

In an aspect, the foregoing method further comprises heat-treating the positive active material precursor at a temperature of 20° C. to 1100° C. during the compacting. For example, the heat-treating may be at a temperature of 20° C. to 1100° C., 200° C. to 1000° C., 400° C. to 900° C., or 600° C. to 800° C.

In an aspect, the positive electrode has a porosity of less than 20 percent (%), 0.01% to 20%, 0.1% to 15%, 0.5% to 10%, or 1% to 5%, based on a total volume of the positive electrode. Porosity may be determined using gas absorption methods, for example, using helium or nitrogen. While not wanting to be bound by theory, it is understood that use of the above-mentioned combination of particle sizes of the positive active material and the solid electrolyte permits use of the above-disclosed porosity while also providing suitable performance, e.g., specific capacity, energy density, or power density. When the above-mentioned combination of particle sizes of the positive active material and the first solid electrolyte are used, improved packing density results in improved specific energy and energy density.

In an aspect, the positive active material layer provides improved specific energy. In an aspect wherein the positive active material is a transition metal oxide comprising nickel and cobalt, the positive electrode active material provides 110 to 175 milliampere-hours per gram (mAh/g), 120 to 165 mAh/g, or 130 to 155 mAh/g, when discharged at a C/20 rate at 25° C. In an aspect, a cell comprising the positive electrode may be charged to 4.2 volts versus Li/Li⁺ at 25° C., and then discharged at a C/20 rate at 25° C. to 3 volts versus Li/Li⁺ to determine the capacity.

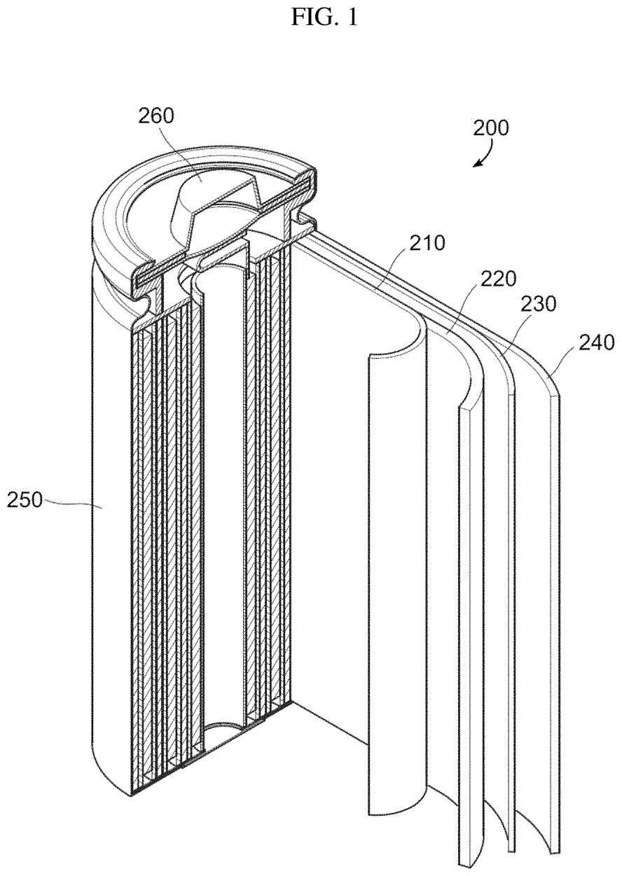

Also disclosed is a solid-state lithium battery. As shown in FIG. 1, the battery 200 comprises: the positive electrode 210; a negative electrode 240; and the solid electrolyte 220 between the positive electrode and the negative electrode. If desired, a separator 230 may be optionally included. The battery comprises a case 250 and a header 260.

The negative electrode may comprise a negative active material, which may comprise lithium metal, a lithium alloy, and may comprise any suitable material that can reversibly absorb and desorb, or intercalate and deintercalated lithium. Lithium metal, a lithium alloy, or a lithium compound, such as lithium titanium oxide, is mentioned. The negative active material may be disposed on a current collector, such as a copper current collector if desired.

The positive active material layer may further include a binder. Any suitable binder may be used.

A binder can facilitate adherence between components of the electrode, such as the positive active material and the conductor, and adherence of the electrode to a current collector. Examples of the binder can include polyacrylic acid (PAA), polyvinylidene fluoride, polyvinyl alcohol, carboxymethyl cellulose (CMC), starch, hydroxypropyl cellulose, regenerated cellulose, polyvinylpyrrolidone, tetrafluoroethylene, polyethylene, polypropylene, ethylene-propylene-diene monomer (EPDM), sulfonated EPDM, styrene-butadiene-rubber, fluorinated rubber, a copolymer thereof, or a combination thereof. The amount of the binder can be in a range of about 1 part by weight to about 10 parts by weight, for example, in a range of about 2 parts by weight to about 7 parts by weight, based on a total weight of the positive active material. When the amount of the binder is in the range above, e.g., about 1 part by weight to about 10 parts by weight, the adherence of the electrode to the current collector may be suitably strong.

The positive active material layer may be prepared by screen printing, slurry casting, or powder compression.

The negative electrode can be produced from a negative active material composition including a negative active material, and optionally, a conductive agent, and a binder. A suitable negative active material includes a material capable of storing and releasing lithium ions electrochemically. The negative electrode active material can comprise a carbon, such as a hard carbon, soft carbon, carbon black, ketjen black, acetylene black, activated carbon, carbon nanotubes, carbon fiber, graphite, or an amorphous carbon. Also usable are lithium-containing metals and alloys, for example a lithium alloy comprising Si, Sn, Sb, Ge, or a combination thereof. Lithium-containing metal oxides, metal nitrides, and metal sulfides are also useful, in particular wherein metal can be Ti, Mo, Sn, Fe, Sb, Co, V, or a combination thereof. Also useable are phosphorous (P) or metal doped phosphorous (e.g., NiP₃). The negative active material is not limited to the foregoing and any suitable negative active material can be used. In an embodiment the negative active material is disposed on a current collector, such as a copper current collector.

In an embodiment, the negative electrode comprises graphite. In an embodiment, the negative electrode comprises lithium metal or a lithium metal alloy. Use of lithium metal is mentioned.

Hereinafter an embodiment is described in detail. The examples are provided for illustrative purposes only and are not intended to limit the scope of the present disclosure.

### EXAMPLES

In the Examples and Comparative Examples, the positive active material will have a composition of LiNi_{0.8}Co_{0.1}Mn_{0.1}O₂ (NCM811), the solid electrolyte will be Li₆S—PS₅—Cl, and the negative active material will be lithium metal. Cell fabrication and testing will be performed as disclosed in Lee et al., Nat. Energy, 5, 2020, 299-308, the content of which is incorporated herein by reference in its entirety. Particle sizes will be determined by laser light scattering and refer to a D₅₀ particle size, unless indicated otherwise. The positive electrode composition of Comparative Examples 1 and 2 and Examples 1 to 3, and the utilization and specific capacity of the positive electrodes are summarized in Table 1, in which CEx indicates a Comparative Example and Ex indicates an Example. In Table 1, wt % refers to weight percent, based on a total weight of the positive electrode active material (NCM811) and solid electrolyte. Each Comparative Example and Example contained 1 wt % carbon. In Table 1, φ is the ratio of the mean diameter of the second positive active material (D₂) to the mean diameter of the first positive active material (D₁), λ is the ratio of the mean diameter of the first positive active material particle (D₁) to the mean diameter of the solid electrolyte (D_{SE}), ϕ is a ratio of the weight of the second positive active material to a total weight of positive active material in the electrode, and f_{CAM} is a total weight of the positive active material (W_{CAM}) to the total weight of the positive active material layer.

TABLE 1

| | NCM811 | | NCM811 | NCM811 | | | | | | | |
|---|---|---|---|---|---|---|---|---|---|---|---|
| | (D₁) | | (D₂) | (D₂) | φ | | | | λ | | Specific |
| Example | D₅₀ = 15 μm | | D₅₀ = 5 μm | D₅₀ = 1.5 μm | (D₂/D₁) | Li₆—PS₅—Cl | | | (D₁/D_{SE}) | Utilization | Capacity |
| CEx 1 | 85 | wt % | 0 | 0 | N/A | 14 wt % | 1.5 | μm | 10 | 75% | |
| CEx 2 | 90 | wt % | 0 | 0 | N/A | 9 wt % | 1.5 | μm | 10 | 25% | |
| Ex 1 (ϕ = 0.25 and | 21.25 | wt % | 63.75 wt % | 0 | 0.3 | 14 wt % | 3 | μm | 5 | 98% | 190 mAh/g |
| f_{CAM} = 85%) | | | | | | | | | | | |
| Ex 2 (ϕ = 0.25 and | 21.25 | wt % | 63.75 wt % | 0 | 0.3 | 14 wt % | 2 | μm | 7.5 | 99% | 192 mAh/g |
| f_{CAM} = 85%) | | | | | | | | | | | |
| Ex3(ϕ = 0.1 and | 9 | wt % | 0 | 81 wt % | 0.1 | 9 wt % | 1.5 | μm | 10 | 99% | |
| f_{CAM} = 90%) | | | | | | | | | | | |
| Ex 4(ϕ = 0.5 and | 45 | wt % | 0 | 45 wt % | 0.1 | 9 wt % | 1.5 | μm | 10 | 98% | |
| f_{CAM} = 90%) | | | | | | | | | | | |

Comparative Examples 1 and 2 include a positive active material having unimodal particle size distribution and Examples 1-4 include a positive active material having a bimodal particle size distribution.

As seen in Table 1, in Comparative Example 1, the positive electrode contained 85 wt % of the positive active material and 14 wt % of the solid electrolyte, based on a total weight of the positive electrode, and resulted in the electrode having a utilization of 75%. In Comparative Example 2, the positive electrode contained 90 wt % of the positive active material and 9 wt % of the solid electrolyte, based on a total weight of the positive electrode, and resulted in the electrode having a utilization of 75%. Thus the utilization of the positive electrode was less when the positive electrode contained 90% of the positive active material having a unimodal particle size distribution.

The surprising effect of a multi-modal particle size distribution in the positive active material on utilization can be seen in Examples 1-4. In Examples 1-4, the utilization of each electrode was above 95%, while the total weight percent of positive active material in the electrode was 90%. Thus when the positive electrode contained a positive active material having a multi-modal particle size distribution, utilization increased, as shown by comparison of Examples 1˜4 to Comparative Examples 1 and 2.

### Ionic Conductivity

Charge-discharge experiments will carried out to measure cathode active material utilization and rate performance, which indicate the ionic conductivity of an electrode that is induced by particle-particle contact. Table 2 shows the capacity and retention results when the mean particle diameter of the solid electrolyte (D_{SE}) is varied in a positive electrode comprising a first positive active material having a mean particle diameter of 16.2 μm and a second positive active material having a mean particle diameter of 5.2 μm. The results shown in Table 2 demonstrate that the capacity retention of the positive electrode remains above 80%, independent of the mean particle diameter of the solid electrolyte, when the positive electrode comprises a multi-modal distribution of positive active materials.

TABLE 2

| | | | Retention |
|---|---|---|---|
| SE size | Capacity @0.1 C | Capacity @1 C | (1 C/0.1 C) |
| 1 μm | 185 | 154 | 82.7% |
| 2 μm | 192 | 162 | 84.4% |
| 3 μm | 190 | 163 | 85.8% |

Various embodiments are shown in the accompanying drawings. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third,” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer or section. Thus, “a first element,” “component,” “region,” “layer,” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the FIGURE. It will be understood that the spatially relative terms are intended to encompass different orientations of the device in use or operation in addition to the orientation depicted in the FIGURE. For example, if the device in the FIGURE is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

“Substituted” means that the compound is substituted with at least one (e.g., 1, 2, 3, or 4) substituent, and the substituents are independently a hydroxyl (—OH), a C1-9 alkoxy, a C1-9 haloalkoxy, an oxo (═O), a nitro (—NO₂), a cyano (—CN), an amino (—NH₂), an azido (—N₃), an amidino (—C(═NH)NH₂), a hydrazino (—NHNH₂), a hydrazono (═N—NH₂), a carbonyl (—C(═O)—), a carbamoyl group (—C(O)NH₂), a sulfonyl (—S(═O)₂—), a thiol (—SH), a thiocyano (—SCN), a tosyl (CH₃C₆H₄SO₂—), a carboxylic acid (—C(═O)OH), a carboxylic C1 to C6 alkyl ester (—C(═O)OR wherein R is a C1 to C6 alkyl group), a C1 to C12 alkyl, a C3 to C12 cycloalkyl, a C2 to C12 alkenyl, a C5 to C12 cycloalkenyl, a C2 to C12 alkynyl, a C6 to C12 aryl, a C7 to C13 arylalkylene, a C4 to C12 heterocycloalkyl, or a C3 to C12 heteroaryl instead of hydrogen, provided that the substituted atom's normal valence is not exceeded. The indicated number of carbon atoms for any group herein is exclusive of any substituents.

While a particular embodiment has been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A positive active material layer comprising:
a positive active material comprising a plurality of particles having multi-modal particle size distribution, wherein the multi-modal particle size distribution comprises a first particle size distribution having a first mean particle diameter (D₁) and a second particle size distribution having a second mean particle diameter (D₂);
a conductive agent; and
a solid electrolyte comprising particles having a mean particle diameter (D_{SE}) of 0.1 micrometers to 12 micrometers,
wherein each of the first mean particle diameter and the second mean particle diameter are independently 1 micrometer to 50 micrometers.

2. The positive active material layer of claim 1, wherein a ratio (ψ) of D₂ to D₁ is equal to or greater than 0.05.

3. The positive active material layer of claim 2, wherein 0.1≤ψ≤10.5.

4. The positive active material layer of claim 1, wherein a ratio of a weight of particles corresponding to the second particle size distribution to a total weight of the positive active material is 0.1 to 0.5.

5. The positive active material layer of claim 1, wherein D₁ is 3 micrometers to 25 micrometers and D₂ is 1 micrometer to 15 micrometers.

6. The positive active material layer of claim 1, wherein a total weight of particles corresponding to the first particle size distribution and the second particle size distribution is greater than or equal to 70 percent of a total weight of the positive active material.

7. The positive active material layer of claim 1, wherein each of the particles corresponding to the first particle size distribution and the particles corresponding to the second particle distribution each independently comprise a lithium transition metal oxide, a lithium transition metal phosphate, or a combination thereof.

8. The positive active material layer of claim 7, wherein the particles corresponding to the first particle size distribution and the particles corresponding to the second particle distribution are each independently a lithium transition metal oxide comprising nickel, cobalt, aluminum, manganese, lithium iron phosphate, or a combination thereof.

9. The positive active material layer of claim 8, wherein the lithium transition metal oxide is lithium cobalt oxide, lithium nickel cobalt manganese oxide, lithium nickel cobalt aluminum oxide, or a combination thereof.

10. The positive active material layer of claim 1, wherein the conductive agent comprises graphite, carbon fiber, activated carbon, carbon nanotubes, carbon black, amorphous carbon, or a combination thereof.

11. The positive active material layer of claim 1, wherein the solid electrolyte comprises a sulfide solid electrolyte, an oxide solid electrolyte, or a combination thereof.

12. The positive active material layer of claim 11, wherein the sulfide solid electrolyte is Li₂S—P₂S₅, Li₂S—P₂S₅—LiX, or a combination thereof, wherein X is at least one halogen element.

13. The positive active material layer of claim 11, wherein the solid electrolyte comprises a garnet solid electrolyte or a perovskite solid electrolyte.

14. The positive active material layer of claim 13, wherein the garnet solid electrolyte is Li_{6.5}La₃Zr_{1.5}Ta_{0.5}O₁₂ and the perovskite solid electrolyte is Li_{0.33}La_{0.5}TiO₃.

15. The positive active material layer of claim 1, wherein a ratio (λ) of D₁ to D_{SE} is equal to or greater than 1.

16. The positive active material layer of claim 15, wherein 2≤λ≤30.

17. The positive active material layer of claim 1, wherein a ratio (f_{CAM}) of a total weight of the positive active material (W_{CAM}) to the total weight of the positive active material layer (W_{TOT}) is equal to or greater than 0.5.

18. The positive active material layer of claim 17, wherein 0.7≤f_{CAM}≤92.5.

19. The positive active material layer of claim 1, wherein 0.1≤ϕ≤0.5, wherein ϕ is a ratio a weight of the second particle (W₂) to a total weight of the positive active material (W_{CAM}).

20. The positive active material layer of claim 1, wherein D_{SE} satisfies
(D₁/(8.926−13.41ψ+3.762ϕ))≤D_{SE}≤D₂.

21. A positive electrode comprising:
a current collector; and
the positive active material layer of claim 1 on a surface of the current collector.

22. A lithium battery comprising:
the positive electrode of claim 21;
a negative electrode comprising a metal current collector; and
a solid electrolyte disposed between the positive electrode and the negative electrode.

23. The lithium battery according to claim 22, wherein the negative electrode further comprises carbon, lithium, a lithium metal alloy, or a combination thereof.

24. A method of preparing a positive active material layer, the method comprising:
providing a mixture comprising a first particle having a first mean particle diameter (D₁) of between 1 micrometer and 50 micrometers, a second particle having a second mean particle diameter (D₂) between 1 micrometer to 50 micrometers;
combining the mixture with a conductive agent and a solid electrolyte having a mean particle diameter (D_{SE}) of 0.1 micrometers to 12 micrometers to form a positive active material precursor; and
compacting the positive active material precursor at 50 megapascals to 500 megapascals to form the positive active material layer,
wherein a positive active material in the positive active material layer comprises a plurality of particles having multi-modal particle size distribution, wherein the multi-modal particle size distribution comprises a first particle size distribution having a first mean particle diameter and a second particle size distribution having a second mean particle diameter.

25. The method of claim 24, wherein a ratio (ψ) of D₂ to D₁ is 0.1≤ψ≤0.5.

26. The method of claim 24, wherein D₁ is 3 micrometers to 25 micrometers and D₂ is 1 micrometer to 15 micrometers.

27. The method of claim 24, wherein a packing density of particles corresponding to the first particle size distribution and particles corresponding to the second particle size distribution in the positive active material layer is equal to or greater than 80 percent, based on a total weight of the positive active material layer.

28. The method of claim 24, wherein the active material loading in the positive active material layer is equal to or greater than 90 percent, based on a total weight of the positive active material layer.

29. The method of claim 24, wherein D_{SE} is 1.5 micrometers to 6 micrometers.

30. The method of claim 24, further comprising heat-treating the positive active material precursor at a temperature of 20° C. to 1100° C. during the compacting.
